(19) United States
(12) Patent Application Publication
(10) Pub. No.: US 2014/0326909 A1
(43) Pub. Date: Nov. 6, 2014

(54) PRESSURE-BALANCED CONTROL VALVES

(71) Applicants: Junhua Ding, Boxborough, MA (US); Zongren Shang, Westborough, MA (US); Zhifeng Liu, Carlisle, MA (US)

(72) Inventors: Junhua Ding, Boxborough, MA (US); Zongren Shang, Westborough, MA (US); Zhifeng Liu, Carlisle, MA (US)

(73) Assignee: MKS INSTRUMENTS, INC., Andover, MA (US)

(21) Appl. No.: 14/265,804

(22) Filed: Apr. 30, 2014

Related U.S. Application Data
(60) Provisional application No. 61/792,999, filed on May 1, 2013.

(51) Int. Cl. F16K 31/06

(52) U.S. Cl. CPC F16K 31/0693
USPC 251/129.07

(57) ABSTRACT

Embodiments of the present disclosure are directed to pressure balanced solenoid control valve for high flow and/or high pressure control applications. An all-sealed integrally formed element functions as both the bellows and spring and is used as a replacement for the combination of both the individual bellows and spring found in existing pressure balanced control valves. The single bellows spring provides a spring force on the movable valve plug and separates opposite sides of the valve plug, wherein a gas passageway is provided between opposite sides of the valve plug so that gas provided at the inlet will flow to opposite sides of the valve plug so as to cancel any pressure forces provided on opposite sides of the valve plug by the pressure of the inlet gas.

### RELATED APPLICATION

This application claims the benefit of U.S. Provisional Application No. 61/792,999, filed on May 1, 2013, the entire content of this application is incorporated herein by reference.

### FIELD OF DISCLOSURE

The present disclosure relates to the field of solenoid valves and, more particularly, to a solenoid-actuated pressure balanced control valve.

### PATENT REFERENCES

U.S. Pat. No. 4,796,854 (Ewing); U.S. Pat. No. 5,582,208 (Suzuki); U.S. Pat. No. 5,927,331 (Suzuki) and U.S. Pat. No. 6,505,812 (Anastas).

### BACKGROUND OF DISCLOSURE

Valves exist in a wide variety of forms and sizes, serving a multitude of purposes, handling the flow of materials whose characteristics range from light gases to heavy slurries and near-solids. Valves can be configured as shut-off valves so as to be operable in either of two states, i.e., completely opened and completely closed. Alternatively, the valves can be proportional control valves so that the valve can be moved though positions between fully closed and fully opened positions so that the flow through the valve can be controlled depending on how much the valve is opened. Valves can be a normally-opened valve in which case the valve is fully opened in the absence of the application of a control signal, or a normally-closed valve in which case the valve is fully closed in the absence of the application of a control signal. Proportional control valves which are capable of responding quickly to control flows with precision and with little electrical power, are of special interest in certain industrial processing, such as flow control of gases and vapors in semiconductor and integrated-circuit manufacture. Mass flow controllers, for example, are widely used in controlling the delivery of process gases in semiconductor manufacturing. Such controllers require accurate control valves so as to deliver very precise amounts of gases during process runs.

Many commercially available mass flow controllers tend to use solenoid valves because solenoid valves are accurate and reliable. Solenoid valves usually each include a valve plunger in the form of plug that moves into and out of contact with a valve seat in response to the application of current to a solenoid coil, which in turn creates flux through a magnetic circuit so as to create an electromagnetic force (emf) on an armature that moves the plug. Because the emf force can be applied to the armature in only one direction, the solenoid valve includes a spring to move the plug in the other direction when the emf force is reduced or removed. Solenoid valves have dominated the designs of mass flow controllers because of their simplicity, low cost and fast response.

Solenoid valves have been designed with a pressure balancing feature, which is particularly useful in neutralizing the forces due to pressure of the gas within the valve when applying the necessary control forces to overcome frictional forces in order to accurately control flow through broad-area flow passages, particularly when opening the valve from a normally closed state. For an example of a pressure-balanced, solenoid proportional control valve designed to reduce these adverse influences on valve performance see U.S. Pat. No. 4,796,854 (Ewing) assigned to MKS Instruments, Inc. of Andover, Mass., U.S.A.

Existing designs, while providing desired operational performance, can prove to be overly complex and expensive for some applications. For example, while such designs can provide excellent proportional-control solenoid-type valves able to swiftly and accurately govern even relatively large volumes and high rates of fluid flow using relatively low levels of electrical power (since the valves are aided by the force counterbalancing achieved through the use of the bellows-type coupling), and/or sensitive and precise valve operation by way of the frictionless suspension of broad-area valve members and the counterbalancing of undesirable pressure-generated forces through a correlated pressure-responsive coupling, the bellows and springs used for such valves can increase cost and complexity in a prohibitive manner for some applications.

### SUMMARY OF DISCLOSURE

The subject technology of the present disclosure provides a cost-effective and simple pressure balanced control valve for high flow and/or high pressure control applications. One example can include a valve assembly with a body having an inlet port, an outlet port, and a valve seat having a passageway connecting the inlet and the outlet ports. A valve plunger is movable along an axis extending through the passageway of the valve seat between an opened and closed position so as to control the flow of gas through the valve, and an electrical solenoid assembly moves the valve plunger when energized to control fluid flow between the inlet and the outlet ports.

In accordance with one aspect of the subject technology, a specially designed all-sealed integrally formed element functions as both the bellows and spring and is used as a replacement for the combination of both the individual bellows and spring found in existing pressure balanced control valves. The valve assembly may further include a metal casing for substantially enclosing the solenoid coil so as to create a path for magnetic flux (a magnetic circuit) in response to a current flowing through the solenoid coil. An all-sealed bellows/spring is positioned between the housing and the valve plunger.

In accordance with another aspect of the subject technology, the valve plunger can function in accordance with one aspect of the subject technology as both the armature and the valve plug.

In accordance with one embodiment, the single bellows spring is attached to the valve plug defining opposite sides of the single bellows spring, and the pressure on opposite sides of the single bellows spring is equalized through an aperture in the valve plug.

In accordance with one embodiment, the pressure on opposite sides of the single bellows spring is equalized through apertures in the single bellows spring.

In accordance with one embodiment, the single bellows spring provides a spring force on the valve plug in the absence of any electromagnetic force.

In accordance with one embodiment, the valve assembly is a normally opened valve assembly.

In accordance with one embodiment the valve assembly is a normally closed valve assembly.

In accordance with one embodiment the single bellows spring includes an undulated pattern.

In accordance with one embodiment the single bellows spring includes an undulated pattern with a single undulation.

In accordance with one embodiment the single bellows spring includes an undulated pattern with a plurality of undulations.

In accordance with one embodiment the single bellows spring is a flat spring.

In accordance with one embodiment the single bellows spring is a leaf spring.

In accordance with one embodiment the single bellows spring is a wave spring.

Valves, valve assemblies, and methods of operation according to the subject technology can provide all the benefits of prior existing valve assemblies, yet provide simpler designs including fewer components that are less costly and easier to assemble together during manufacturing. One consequence of the simpler design is that the parts can be all metal, such as stainless steel, providing better and more long lasting non-reactive material with most reactive gases.

These and other features and benefits of the present disclosure will become more apparent upon reading the following detailed description in combination with the accompanying drawings.

### BRIEF DESCRIPTION OF DRAWINGS

The foregoing and other features and advantages of this disclosure will be better understood from the detailed description and the drawings, in which:

FIG. 1 is a simplified cross-sectional view of the simplified valve assembly constructed in accordance with the technology described herein;

FIG. 2 is more detailed cross-sectional view of the valve assembly constructed in accordance with the technology described herein;

FIGS. 3A and 3B is one embodiment of the combined valve spring/bellows;

FIGS. 4A and 4B is a second embodiment of the combined valve spring/bellows;

FIG. 5 is cross sectional view of a third embodiment of a valve assembly constructed in accordance with the technology described herein;

FIG. 6 is an exploded view of a mass flow controller assembly including the improved control valve; and

FIG. 7 is a cross-sectional view of a mass flow controller including a valve assembly of the type described herein.

### DETAILED DESCRIPTION OF DISCLOSURE

Embodiments of the subject technology can include a valve assembly in which an all-sealed (completely sealed) spring is used the provide the functions of both the (i) valve spring and (ii) bellows for pressure balance, i.e. the valve spring and the bellows are combined as one piece. For some embodiments, the armature and valve plug can be combined as one integrally-formed piece/unit. For some embodiments, the valve orifice can be directly opened on the flow body surface to reduce the cost and/or to avoid surface distortion caused by the press fit.

According to some aspects, the new pressure balanced control valve has fewer components so the material cost is much less than existing pressure balanced control valves. Further, the new pressure balanced control valve is much easier to assemble such that the labor cost or material cost is greatly reduced.

The valve assemblies of the subject technology can be used in high flow and/or high pressure control applications.

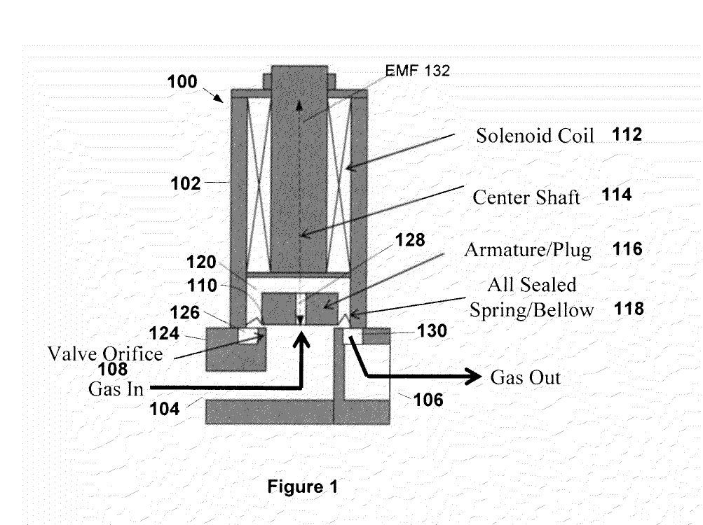

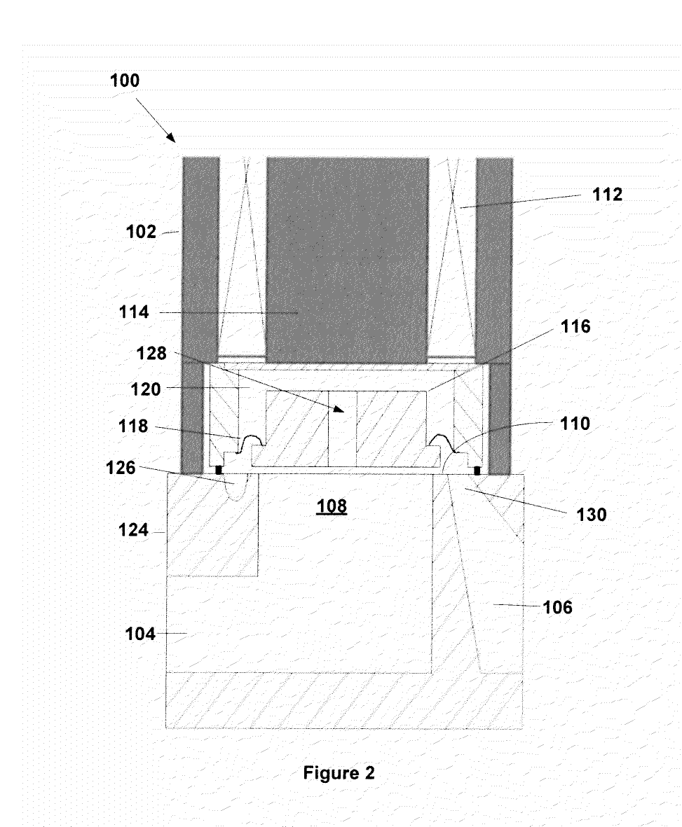

Referring to FIGS. 1 and 2, the present disclosure provides a precision high flow-rate solenoid valve assembly 100, which is capable of proportional-control of large volumes of fluid in response to relatively low-power electrical control signals. The valve assembly 100 provides all the benefits of prior existing valve assemblies, yet has a simpler and more inexpensive design including fewer components that are easier to assemble together during manufacturing.

The valve assembly 100 includes a valve housing 102 having a fluid inlet 104, a fluid outlet 106, a valve orifice 108 in fluid communication with the inlet and defining a valve seat 110. The valve assembly 100 includes a solenoid coil 112 and a center shaft 114 made of a ferromagnetic material. The coil is also substantially enclosed with a casing made of a ferromagnetic material so that electric current flowing through the coil produces magnetic flux through a flux path including the center shaft and the casing. The magnetic flux will produce an emf force on the valve plunger 116 which is also made of a ferromagnetic material. The valve plunger 116 includes the functionality of both the armature and plug, which as shown is an integral part designed to perform both functions. The combined, all-sealed, bellows/spring 118 supports the valve plunger 116 in the valve chamber 120. A base housing assembly 124 defines the bottom of the chamber 120, as well as the valve orifice 108, valve seat 110, gas exit 130 (to the outlet 106) and groove 126 surrounding the valve seat 110 and connected to the gas exit 130 to insure that gas between base housing assembly 124 and the bellows/spring 118 exits through the gas exit 130 to the outlet 106.

The valve plunger (armature/plug) 116 includes a gas passageway 128 between the valve orifice 108 and the valve chamber 120 so that the gas pressure is always the same in both locations so as to neutralize any forces that may be exerted on the valve plunger 116 by the gas pressure. As a result the only forces on the valve plunger will be those exerted by the bellows/spring 116 and the emf exerted through the shaft 112 in response to an electric current flowing in the solenoid coil 110. In this regard the valve assembly can be normally closed in the absence of a current in the solenoid coil 110, held in place by the bellows/spring 118. The spring bellows 118 can be preloaded to insure the plunger 116 seals on the valve seat 110 in the absence of an applied current to the coil 112. Gas at the inlet 104 will always flow through the passageway 128 into the valve chamber 120 regardless of the position of the plunger 116. For a normally closed valve, when an electric current flows into the solenoid coil 112, a magnetic field is created through the shaft and housing so that an emf force 132 is applied through shaft 112 to the plunger 116 moving it away from the valve seat 110 against the action of the bellows/spring 118. When the emf force 132 is removed (in response to the electric current no longer flowing in the coil), the plunger 116 is forced back against the valve seat 110 because of the relaxation of the bellows/spring 118. For a normally opened valve, when an electric current flows into the solenoid coil 112, a magnetic field is created through the shaft and housing so that an emf force 132 is applied through shaft 112 to the plunger 116 moving it toward the valve seat 110 against the action of the bellows/spring 118. When the EMF force 132 is removed (in response to the electric current no longer flowing in the coil), the plunger 116 is forced back away from the valve seat 110 because of the relaxation of the bellows/spring 118. The EMF 132 is thus shown in FIG. 1 as applied in either of two directions depending on whether the valve is normally opened or normally closed. It should be appreciated that the bellows/spring 118 is all sealed (no openings between the chamber 120 and the orifice 108).

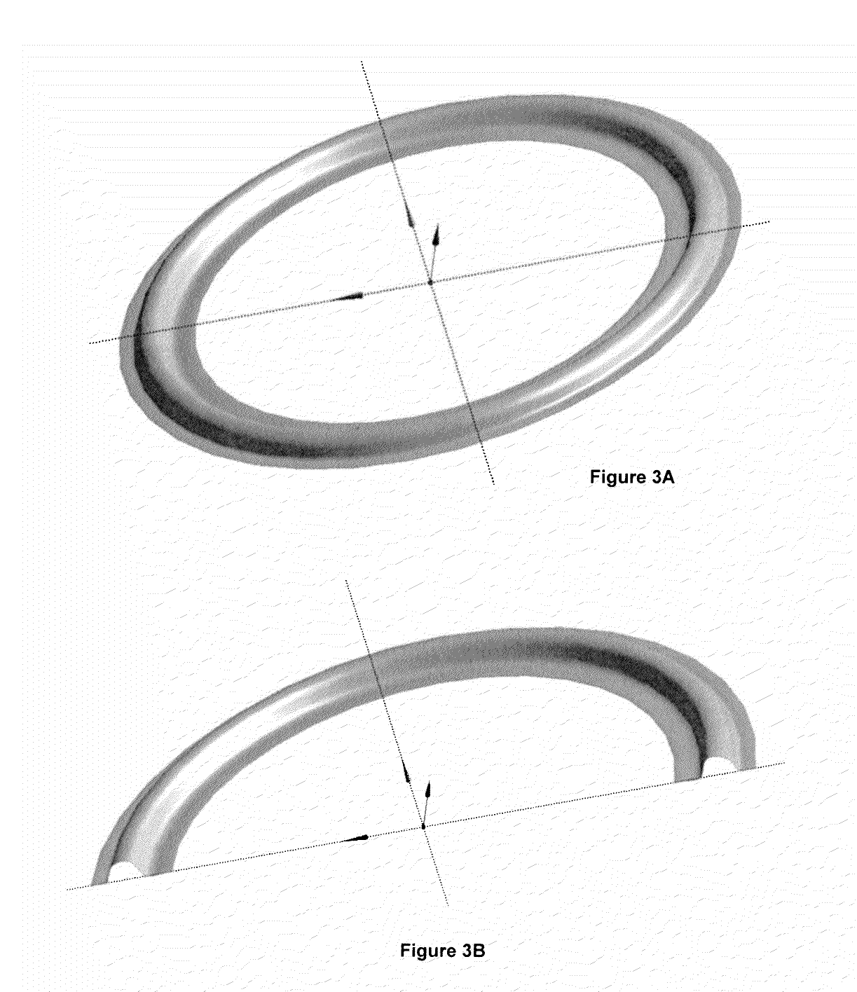

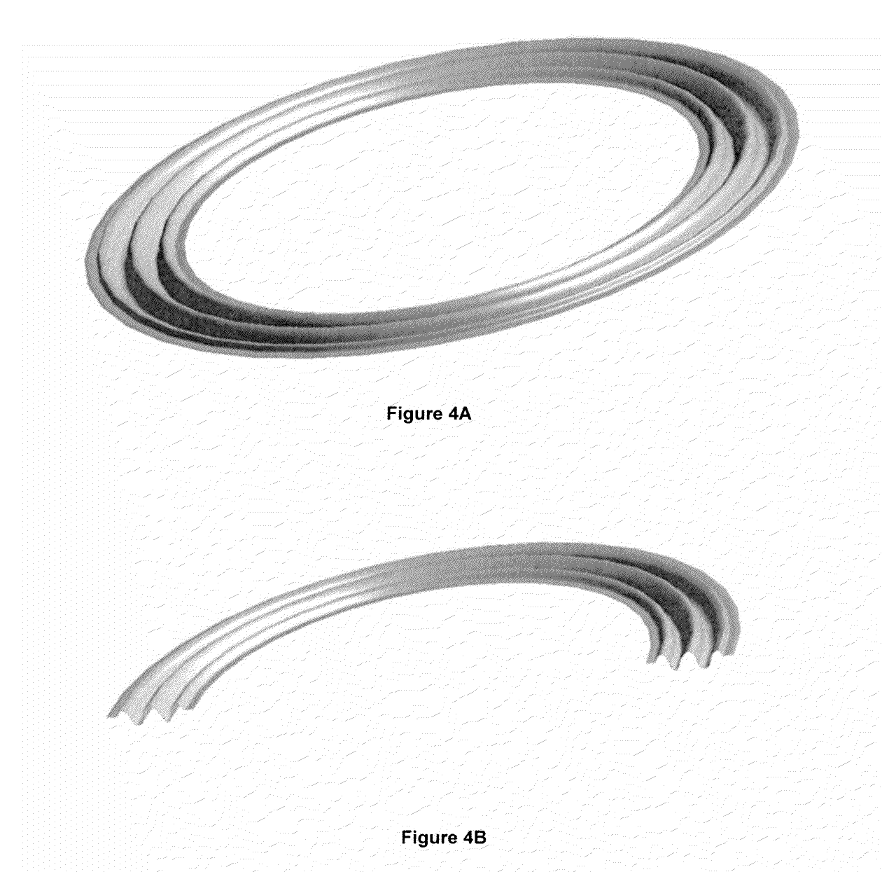

Examples of the bellows/spring are shown in FIGS. 3A-3B and 4A-4B, wherein examples of the bellows/spring are shown as formed with an undulated groove, or multiple undulated grooves so as to function as a spring with extended spring action providing extended displacement of plunger 116. Note that the spring constant of the bellows/spring is a function of the design of the bellows spring, including the thickness and material of the bellows/spring, and the geometry and formation of the undulated groove design.

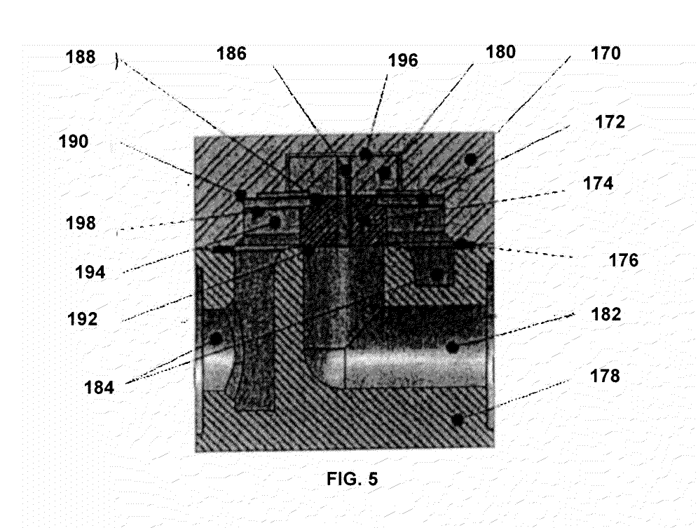

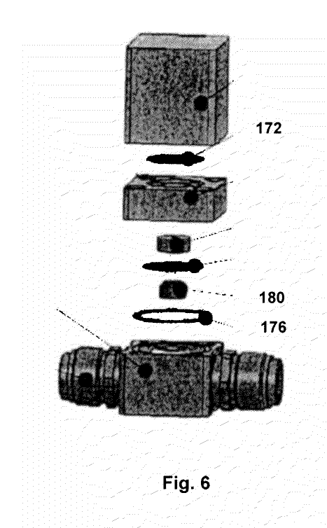

In FIGS. 5 and 6, an alternative arrangement of the valve assembly is shown. The pressure-balanced, solenoid proportional control valve shown in FIG. 5 includes a top seal cover 170, spring 172, plug 174, external seal 176, valve body 178, armature 180, inlet 182, outlet 184, through hole 186, seal to plug 188, seal to top seal cover 190, valve seal interface 192, lower gas chamber 194, upper chamber 196 and an additional, optional spring 198.

Sealing is provided between plug 188 and top seal cover 190, with lower gas chamber 194 and upper gas chamber being separated by spring 172. Inlet 182 and outlet 184 are divided by the valve seal interface 192 so as to form the upstream and downstream portions of the valve. Outlet 184 and lower gas chamber 194 are in fluid communication with one another. In operation, fluid enters at inlet 182, passes through hole 186 and enters upper chamber 196. Once fluid enters the inlet, armature 180, the upper surfaces of spring 172 and the lower surface of plug 174 are under upstream pressure. The lower end of spring 172 and other surfaces of plug 174 are under the same pressure as in the outlet 184. Spring 172 can be preloaded so that plug 174 can have a predetermined spring loading force applied to it biasing the spring to the normally closed position. If spring 172 is incapable of providing the desired spring loaded force, optional spring 198 can be added to provide the added force. It is noted that spring 198 should not divide the upper chamber in two. Accordingly, spring 198 is provided with openings. Through design, without spring loading, the reaction force at plug 174 and valve body 178 at the interface 192 can be controlled, say to be zero or a predefined value. With spring preloading, the sealing force between plug 174 and valve body 178 at the interface 192 will be the spring preloading force plus the reaction force mentioned above. It should be noted that external seal 176 seals the fluid inside the valve.

Regarding the structure of FIG. 6, external seal 176 can be made of any number of materials such as rubber or stainless steel. Spring 172 can be a flat, leaf or a wave spring. Armature 180 can be made of any number of magnetic and soft magnetic materials depending on the design or the valve.

FIG. 6 shows the valve assembly of FIG. 5 in an exploded view.

In its most basic design the presently disclosed valve assembly has fewer components, and which can be assembled together more easily in comparison to previously existing valve assemblies, such as the valve assembly disclosed in U.S. Pat. No. 4,796,854.

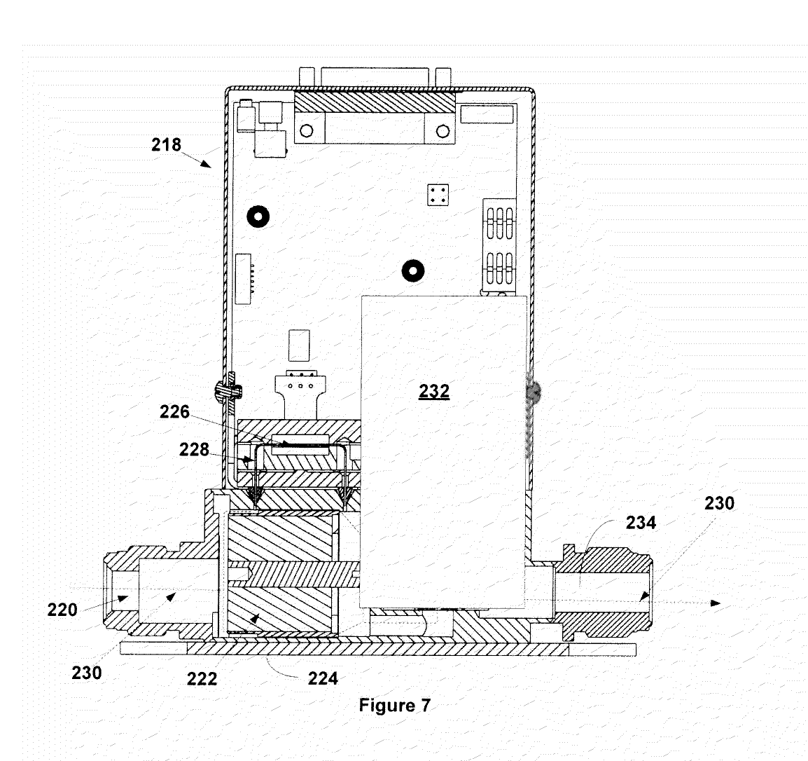

As an example of an application for the above-described valve assembly, a mass flow controller (MFC) incorporating a valve assembly of the type described herein is illustrated in FIG. 7. As shown in FIG. 7, for example, a typical MFC 218 includes an MFC inlet 220. The gas entering the inlet flows around a gas flow bypass element 222 positioned within a housing 224. A portion of the gas flowing around the bypass element will flow through a thermal sensor 226. Thermal flow sensor 226 includes a capillary tube 228 and provides an output signal representative of the mass flowing through the mass flow controller 218. In general, the gas flow bypass element 222 is constructed so that the gas flow, indicated by the path 230 is laminar within the housing 224 around the bypass element. A portion of the gas will flow through the capillary tube 228. So long as the flow around the bypass element is laminar, the ratio of mass of gas flowing though the capillary tube to that of the mass of gas flowing around the gas flow bypass element will remain constant. The thermal flow sensor 226 includes a heater and a pair of coils (not shown) that are used to measure the flow of gas through the capillary tube. This measured flow can be used to control the solenoid valve 232 (based on the principles of the improved solenoid valve described herein) in order to maintain the mass flow rate though the mass flow controller at a set flow rate. In this manner the MFC includes a controller for receiving an input representative of the setpoint, and an input representative of the actual flow, and an algorithm for correcting any errors between the two by controlling the position of the control valve. As shown in FIG. 7, the gas flows through the valve plunger of the valve assembly and out the gas outlet 234.

As is known, an MFC is for controlling the flow rate of a gas from a source and can be used, for example, in the semiconductor manufacturing industry to precisely deliver a process vapor to a process chamber for making a semiconductor wafer. The built MFC can be a temperature-based MFC, for example as shown in FIG. 7. However, the valve assembly can also be incorporated in a pressure-based MFC, as well as other types of flow control devices.

It should be noted that because of the more simple design, it is possible that all of the parts can be made of metal materials, such as stainless steel.

The built MFC includes a flow path connected to the inlet of the valve assembly, a flow sensor assembly for sensing flow through the flow path, and a control device programmed to receive a predetermined desired flow rate from a user, receive an indication of flow from the flow sensor assembly, and determine an actual flow rate through the flow path. The control device is also programmed to instruct the valve assembly to increase flow if the actual flow rate is less than the desired flow rate, and to decrease flow if the actual flow rate is greater than the desired flow rate. As used herein, the phrase “control device” encompasses its plain and ordinary meaning, including but not limited to a device or mechanism used to regulate or guide the operation of the MFC. The control device preferably comprises a computer processing unit (CPU) including at least a processor, memory and clock. The control device operates in a feedback loop to maintain the desired flow at all times. Information on flow rate as a function of the solenoid valve assembly 10 control current is preferably stored in the control device in order to quicken the response time of the MFC.

The embodiment and practices described in this specification have been presented by way of illustration rather than limitation, and various modifications, combinations and substitutions may be effected by those skilled in the art without departure either in spirit or scope from this disclosure in its broader aspects.

The subject technology is illustrated, for example, according to various aspects described below. Various examples of aspects of the subject technology are described for convenience. These are provided as examples, and do not limit the subject technology.

What is claimed is:

1. A solenoid valve assembly comprising:
an inlet;
an outlet;
a solenoid coil;
a magnetic circuit;
a valve seat;
a valve plug movable relative to the valve seat in response to an electromagnetic force provided by the solenoid coil and magnetic circuit;
a single bellows spring for providing a spring force on the valve plug and separating opposite sides of the valve plug, wherein a gas passageway is provided between opposite sides of the valve plug so that gas provided at the inlet will flow to opposite sides of the valve plug so as to cancel any pressure forces provided on opposite sides of the valve plug by the pressure of the inlet gas.

2. A solenoid valve assembly according to claim 1, wherein the single bellows spring is attached to the valve plug defining opposite sides of the single bellows spring, and the pressure on opposite sides of the single bellows spring is equalized through an aperture in the valve plug.

3. A solenoid valve assembly according to claim 1, wherein the pressure on opposite sides of the single bellows spring is equalized through apertures in the single bellows spring.

4. A solenoid valve assembly according to claim 1, wherein the single bellows spring provides a spring force on the valve plug in the absence of any electromagnetic force.

5. A solenoid valve assembly according to claim 1, wherein the valve assembly is a normally opened valve assembly.

6. A solenoid valve assembly according to claim 1, wherein the valve assembly is a normally closed valve assembly.

7. A solenoid valve assembly according to claim 1, wherein the single bellows spring includes an undulated pattern.

8. A solenoid valve assembly according to claim 1, wherein the single bellows spring includes an undulated pattern with a single undulation.

9. A solenoid valve assembly according to claim 1, wherein the single bellows spring includes an undulated pattern with a plurality of undulations.

10. A solenoid valve assembly according to claim 1, wherein the single bellows spring is a flat spring.

11. A solenoid valve assembly according to claim 1, wherein the single bellows spring is a leaf spring.

12. A solenoid valve assembly according to claim 1, wherein the single bellows spring is a wave spring.

13. A solenoid valve assembly comprising:
an inlet;
an outlet;
a valve seat:
solenoid coil; a single integrally formed valve armature/plug configured to engage the valve seat when the valve assembly is in the closed position, and move away from the valve seat when opening the valve assembly;
a single bellows spring for providing a spring force on the valve armature/plug; and
a magnetic circuit for providing an electromagnetic force, opposite the spring force, on the valve armature/plug for moving the armature/plug relative to the valve seat.

14. A valve assembly of claim 13, wherein the spring/bellows and armature/plug are made of metal materials.

15. A mass flow controller comprising:
a flow sensor for sensing the flow of gas through the mass flow controller; and a solenoid valve assembly comprising:
a solenoid coil;
a magnetic circuit;
a valve seat;
a valve plug movable relative to the valve seat in response to an electromagnetic force provided by the solenoid coil and magnetic circuit; and
a single bellows spring for providing a spring force on the valve plug and separating opposite sides of the valve plug, wherein a gas passageway is provided between opposite sides of the valve plug so that gas provided at the inlet will flow to opposite sides of the valve plug so as to cancel any pressure forces provided on opposite sides of the valve plug by the pressure of the inlet gas.
